(19) United States
(12) Patent Application Publication
(10) Pub. No.: US 2003/0071179 A1
(43) Pub. Date: Apr. 17, 2003

(54) Support assemblies

(76) Inventor: Cluny John Mearns, Gloucestershire (GB)

Correspondence Address: YOUNG & THOMPSON, 745 SOUTH 23RD STREET 2ND FLOOR, ARLINGTON, VA, 22202

(21) Appl. No.: 09/973,723

(22) Filed: Oct. 11, 2001

(51) Int. Cl. F16M 11/00

(52) U.S. Cl. 248/163.1

(57) ABSTRACT

An upwardly extending structure is secured to a based support system comprising a series of individual blocks 25 interlocked with a linking beam 26. Each incorporates a groove in its top face which receives the linking beam 26. U-shaped bolts 29A are located in grooves formed in the two sides of the block 25 and running around the base. The ends of the bolts will be fixed to securing plates 29B. Each block has a pair of protrusions and a pair of recesses in both side walls so that the blocks can be interlocked with one another. This reduces the need for all of the blocks to be positively attached to the linking beam 26. Thus, pairs of blocks can be unsecured to the linking beam between two blocks which are positively attached to the beam 26. Attachment plates 32 can be secured to the sides of the linking beam 26.

There is a growing trend to install communications antennae on roofs of buildings. There is also a need in some circumstances to install safety railings or other upwardly extending structures on roofs or other exposed places. The support for such structures needs to be robust and stable, but nevertheless capable of being installed relatively easily. It is therefore an object of this invention to provide a support base for an upwardly extending structure, such as a mounting for an antenna, that will be suitably robust and stable and which can readily be assembled on site.

From one aspect, this invention provides a support base for an upwardly extending structure and comprising a series of individual blocks and a linking structure extending along the length of the line of blocks, the blocks and linking structure being releasably interlocked with one another to form the foot of the base assembly, with the linking structure also providing a mounting area for said structure.

With such an assembly, the blocks can be constructed to dimensions and be of a weight such that they tend to resist tendency to movement of any structure connected to the assembly. In particular, the blocks can have substantial width, relative to their depth in the longitudinal direction of the beam. This enables each block to act as a ballast member and to spread load, whilst enabling it to be lifted and manipulated into position to form part of the whole assembly. Preferably the blocks will carry interengaging protrusions and recesses so that they can be interlocked.

It may be advantageous to provide that a securing device interlocking the linking structure to a block is provided for only some of the blocks, with the blocks inbetween those held by securing devices being held together by said interengaging protrusions and recesses.

In the preferred form, each block incorporates a slot running around the sides and base of the block for receipt of a securing device in the form of a U-bolt to be secured to said linking structure or to a plate mounted above said linking structure. Furthermore, each block can have a groove formed into its top face to house the extending linking structure.

As an alternative but less preferred arrangement the linking structure can comprise a continuous beam with upper and lower flanges in cross section, with the blocks defining slots for fitting over said lower flange section of the beam to lock the blocks to the beam.

In this arrangement the beam may have the horizontal lower flange on which the blocks are to be located. The beam could have a horizontal upper flange providing the mounting area for the structure to be supported.

The assembly could readily have upright supports secured to said linking structure. Such supports could carry hand rails, for example.

From a further aspect, the invention provides a mounting for an antenna, the mounting comprising an upright mounting pole, two base support members in the form of beams extending generally at right angles to one another and connected to said mounting pole and to triangulated support braces mounted between the base support members and said mounting pole.

This provides a rigid stable support for an antenna to be attached to the upper part of the mounting pole. The base support members, set at right angles to one another, can then readily be located, for example, into the corner of a roof of a building where significant structural strength of the roof might be expected. A further advantage is that the angled base support can be positioned around obstructions.

Ideally, mounting rungs will be provided on the mounting pole, together with an operating platform carried by horizontal support braces of the triangulated structure. Parts of the triangulated structure may be connected to one another by gusset plates and held by bolts.

It is preferred that the antenna mounting should form part of a support base assembly of this invention, as herein before defined, wherein the base support members are provided by said linking structure.

The invention may be performed in various ways and preferred embodiments thereof will now be described, by way of example, with reference to the accompanying drawings.

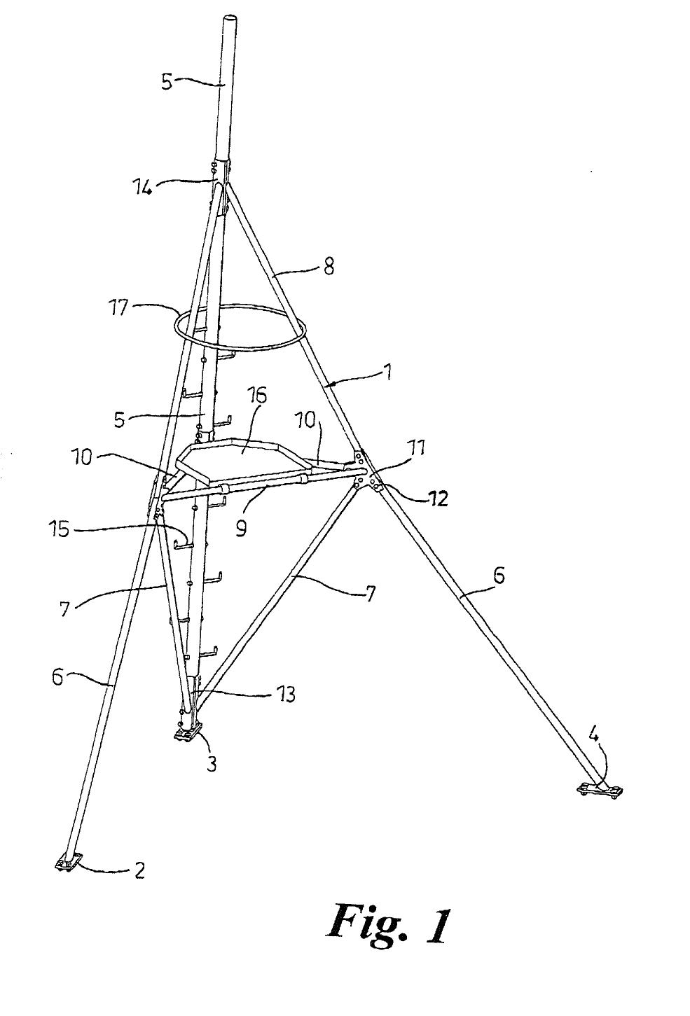

FIG. 1 is a perspective view of one form of a tripod support of this invention for mounting an antenna;

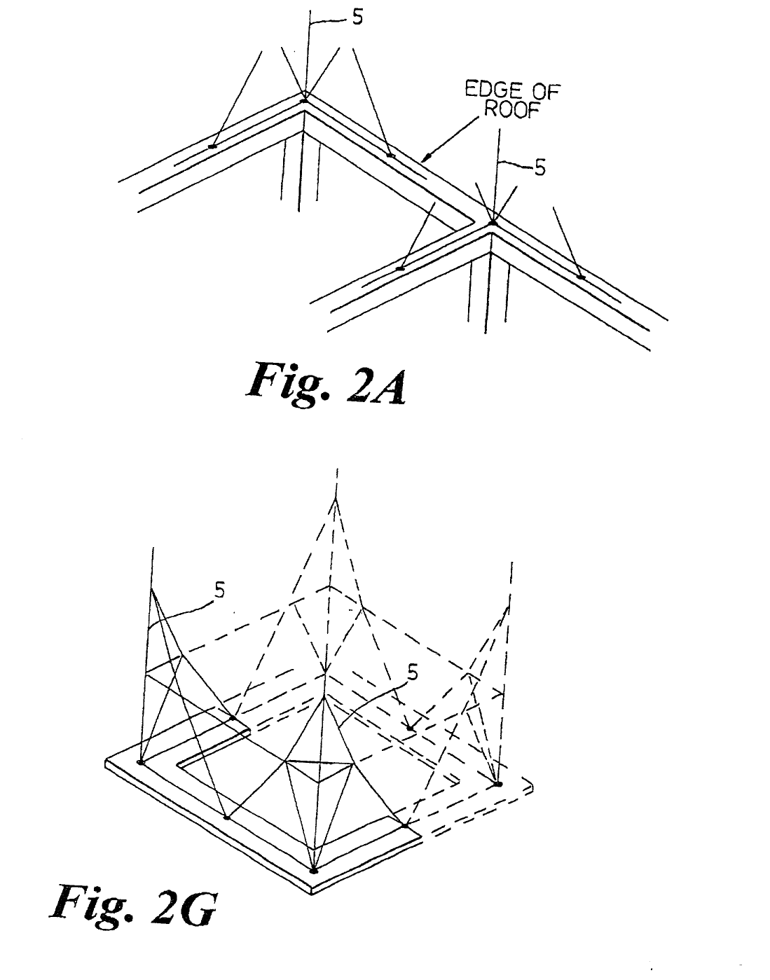

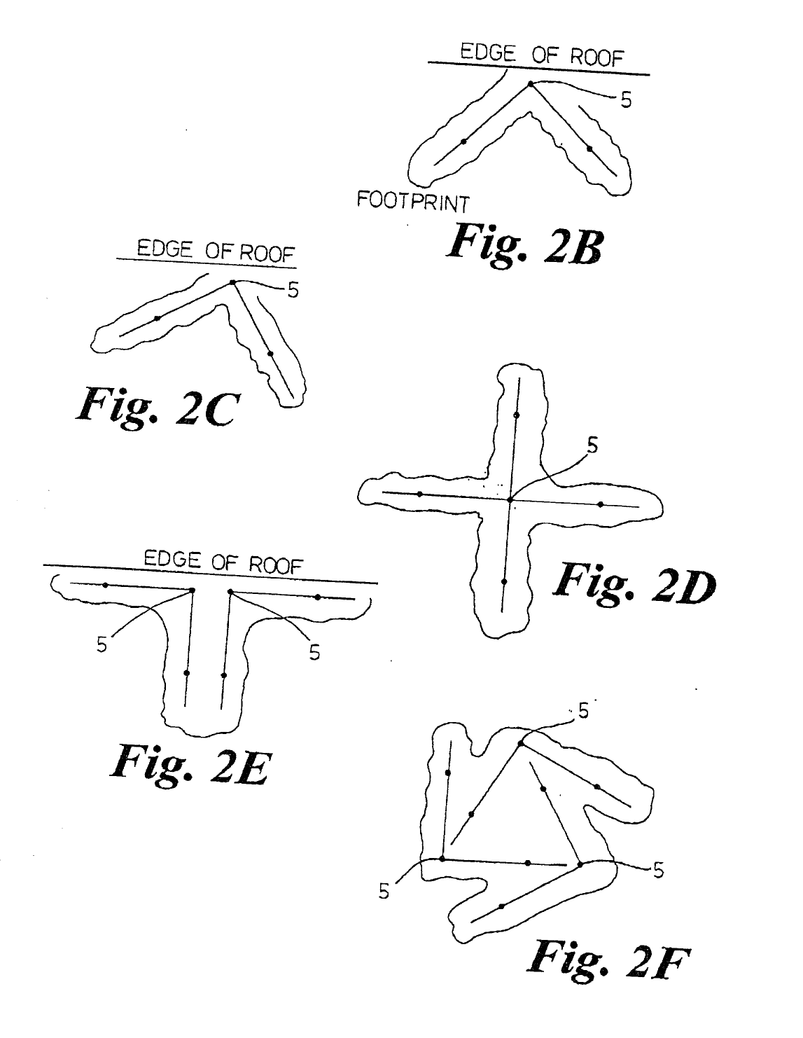

FIGS. 2A to 2G illustrate various ways of mounting one or more tripods as shown in FIG. 1;

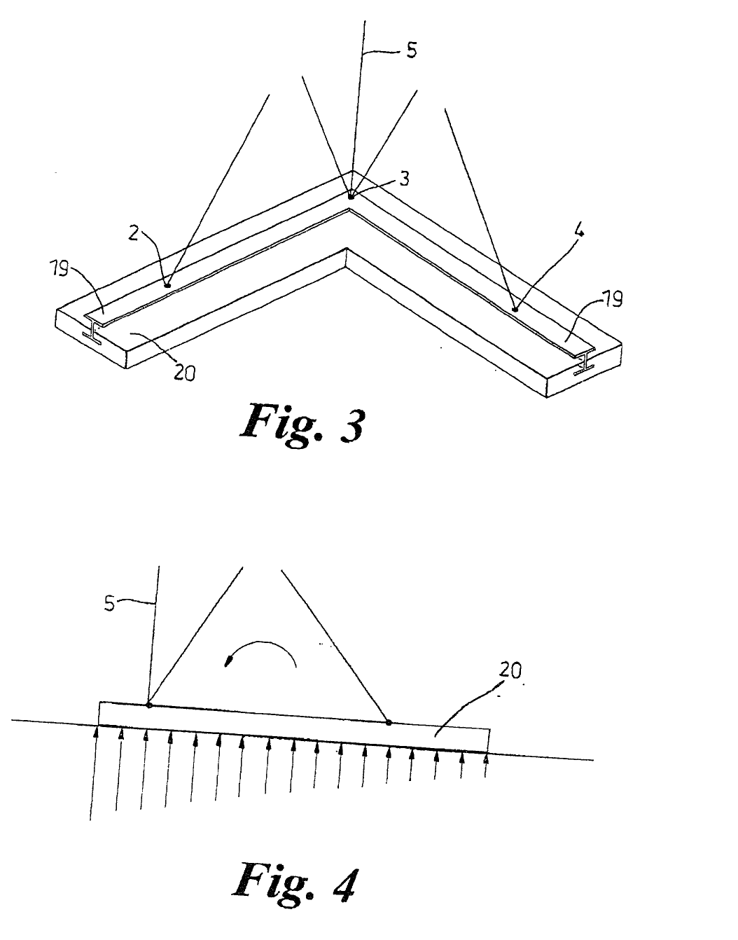

FIG. 3 illustrates features of an example of a base support system of the invention for the tripod of FIG. 1;

FIG. 4 is a side view of the support system shown in FIG. 3;

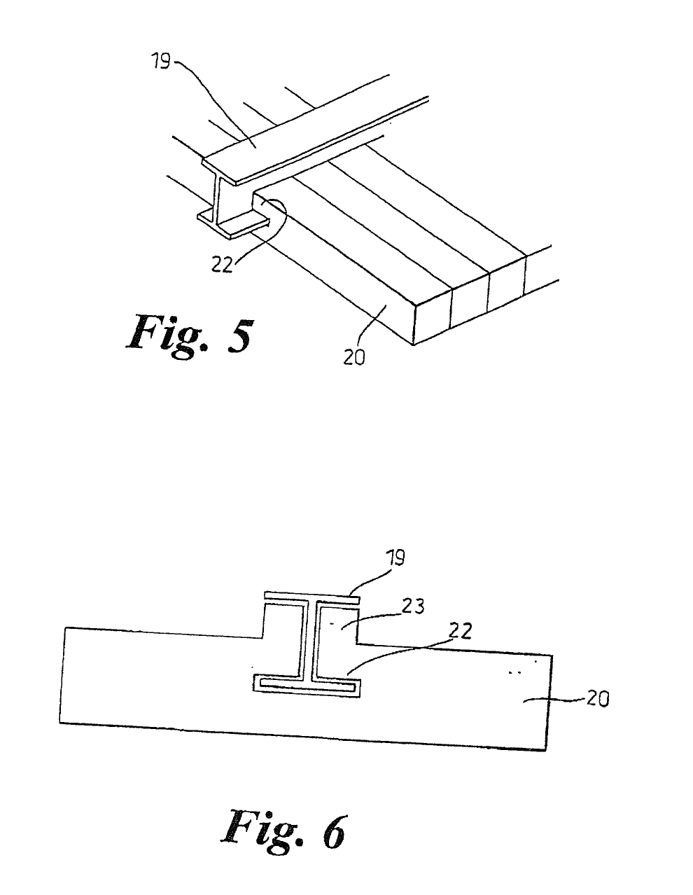

FIG. 5 is a perspective view of a detail of the arrangement of FIG. 3;

FIG. 6 is an end view of the detail shown in FIG. 5;

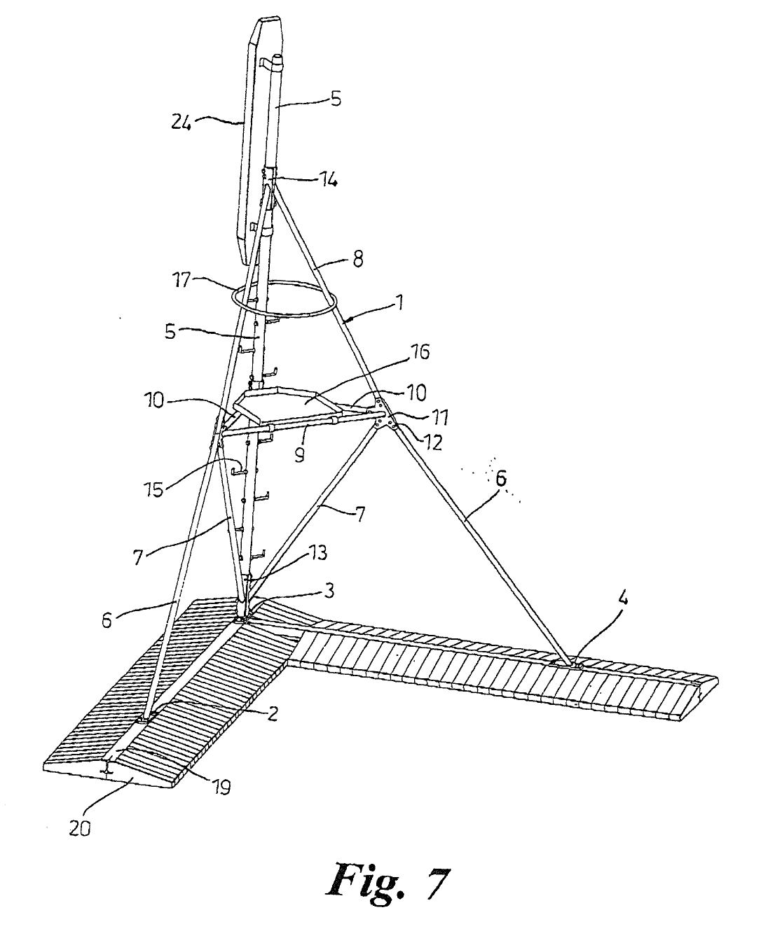

FIG. 7 is a rear perspective view of a complete tripod and support system of another embodiment of this invention;

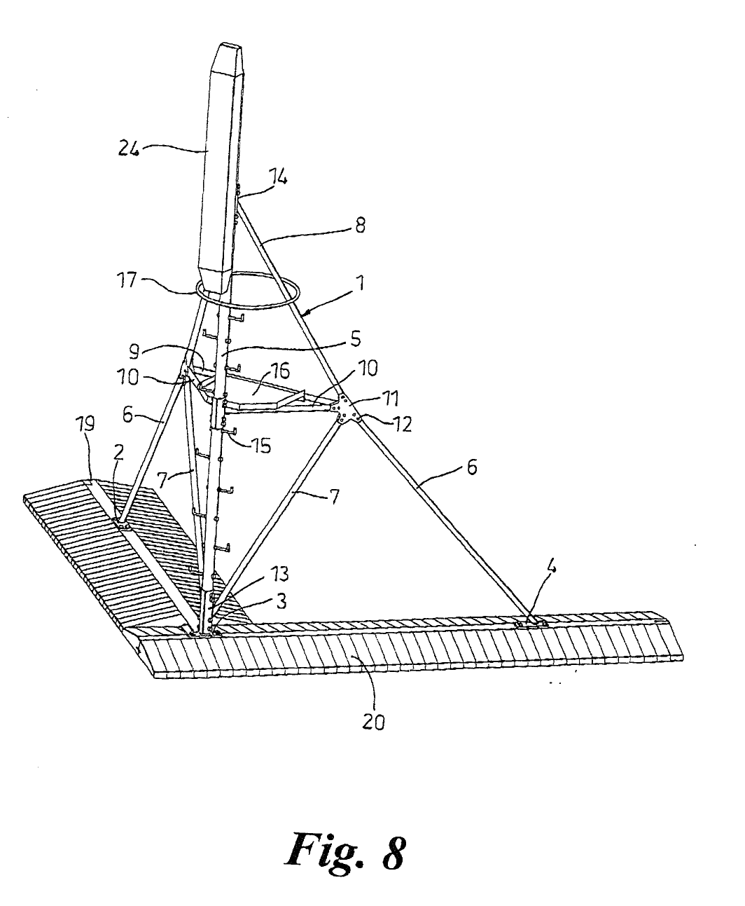

FIG. 8 is a front perspective view of the system shown in FIG. 7;

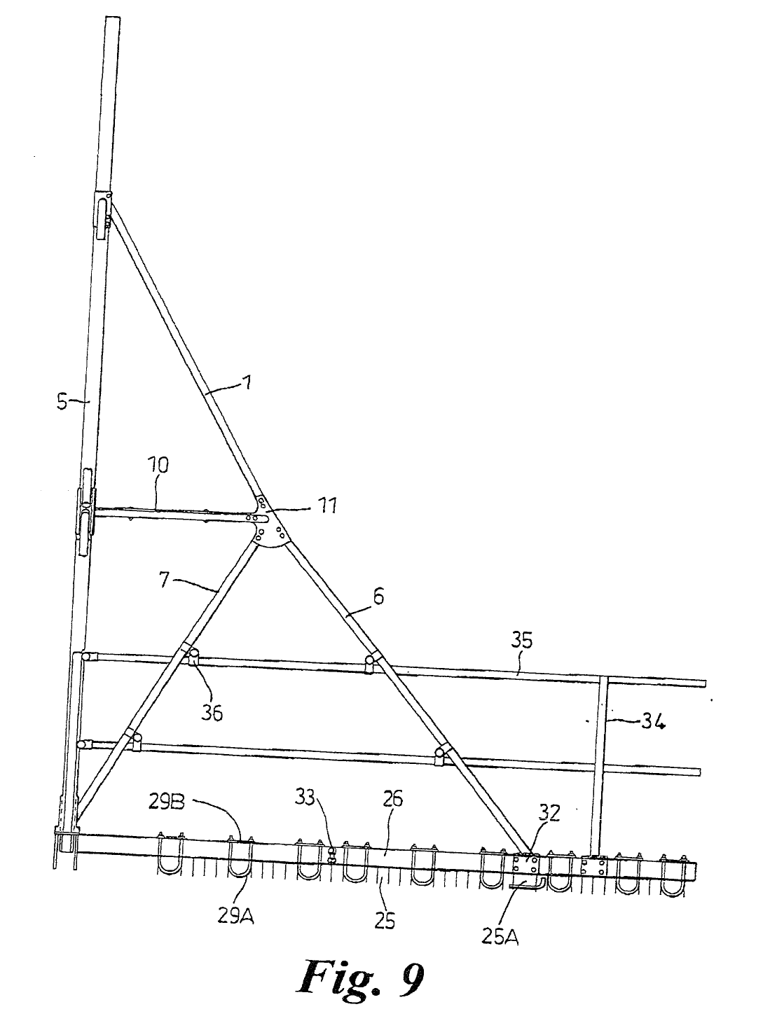

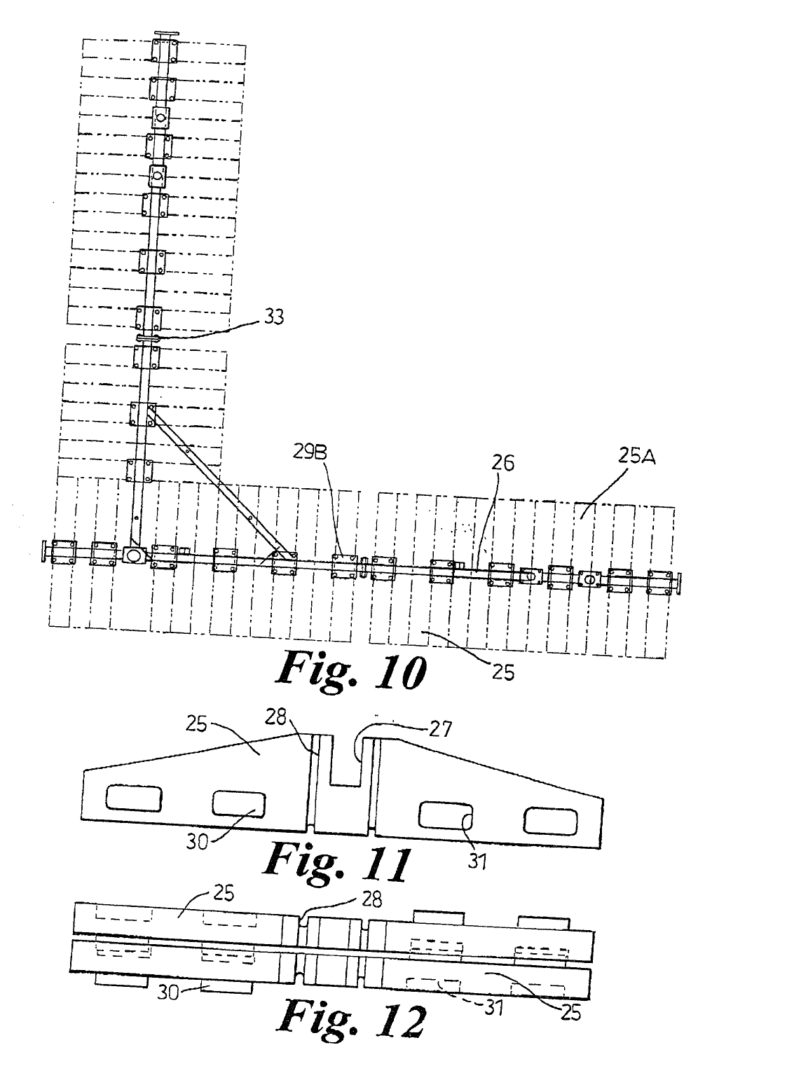

FIGS. 9 and 10 are side and plan views respectively of an alternative and preferred embodiment of a complete tripod and support system of this invention;

FIG. 11 is a side view of one of the blocks forming part of the base of the support system of FIGS. 9 and 10;

FIG. 12 is a plan view showing how two of the blocks of FIG. 11 may be interconnected;

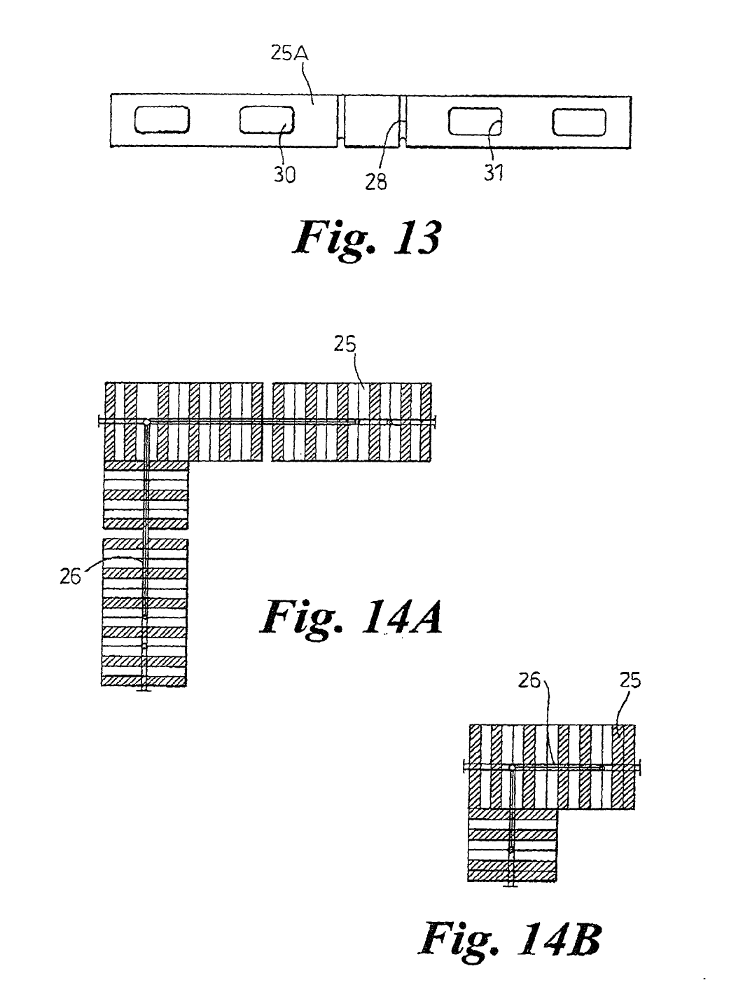

FIG. 13 is a side of an alternative form of block for use in the assembly of FIGS. 9 and 10; and

FIGS. 14A and 14B illustrate alternative arrays for base assemblies of a structure of the form as shown in FIGS. 9 and 10.

The tripod system 1 shown in FIG. 1 is built upon mounting feet 2, 3 and 4. A mounting pole 5 extends up from the foot 3. The pole is supported by various triangular structures created by additional connecting tubes 6, 7, 8, 9 and 10. The tube 9 is welded to gusset plates 11, which in turn provide connection points for securing the tubes 6, 7, 8 and 10 by means of bolts 12 and matching outer plates. Connections could elsewhere incorporate half-tube sections which will sit around the tubes. Half tube connection plates 13 and 14, for example, enable other tubes welded to them to be connected by bolts to the mounting pole 5. An antenna will be mounted on to the top of the pole 5. Step bolts 15 or rungs are provided on the pole 5 to allow access to the top area where the antenna will be mounted. Alternatively, a removable ladder could be provided. The tubes 9 and 10 support a platform 16 which is hinged onto the tube 9 so that the operator can move it aside as he climbs up and then lower the platform to provide a working base. A loop handrail 17 can be secured over the tubes B and mounting pole 5 as illustrated.

The structure shown in FIG. 1 provides a strong, rigid support for an antenna on the mounting pole 5, which can readily be constructed on site from a series of lightweight components. The three point base of the tripod 1 defines an L-shape so that it can be set into the corner of a roof of a building where the building structure is likely to be strongest. Furthermore, the tripod can be set in any desirable position, for example to avoid rooftop obstructions or to sit over known structural strong points. The standard location for the tripod and a simple alternative are shown in FIG. 2A. FIGS. 2B and 2C shows the tripod set non-symmetrically with respect to the roof structure two or more tripods can be used together. Thus, as shown in FIG. 2D, a dual tripod construction can be created based around a single mounting pole 5. A T-shaped structure incorporating two mounting poles 5 can be created by positioning a pair of tripods as shown in FIG. 2E. FIG. 2F illustrates how three tripods can be nested within one another to provide a compact array for three mounting poles 5. Finally, FIG. 2G shows how two or four tripods could be combined to make a unit with greater capacity.

Preferably, the feet 2, 3 and 4 of the tripod will be connected to some form of load spreading assembly such as that shown in FIG. 3. Thus the feet 2, 3 and 4 will be bolted on to an I-shaped beam 19. If desired, the “I-beam” could be created from a pair of channel-section members mounted back to back. Each of these I-beams will have a series of interlocking blocks 20 slid over the beam section to provide a required weighting to resist unbalancing of the tripod. The blocks 20 form a support base as shown in FIG. 5. The blocks 20 could be increased in width it desired to provide added weighting and stability.

FIGS. 5 and 6 show shaping of the blocks 20 so as to provide a lip 22 to fit over one of the flanges of the I-beam. As shown in FIG. 6, the lip 22 can extend upwardly at 23 to sit fully between the two flanges of the I-beam 19.

A complete arrangement is illustrated in FIGS. 7 and 8. In this instance, each I-beam 19 supports a series of blocks 20 of significant width (essentially of a flattened triangular shape in cross-section), but of relatively narrow depth. This enables a robust assembly to be created from the individual parts which can readily be carried to the final site. The full assembly shows an antenna 24 fitted on to the mounting pole 5.

The basic support structure comprising the I-beam 19 and the individual blocks 20 can be used also to provide a mounting of support bars for a handrail. The base of each support bar will be bolted on to the I-beam 19. The handrail could form an additional part of the whole assembly shown in FIGS. 9 and 10. Alternatively, an independent handrail system could be provided separate from the tripod support on its own independent support base comprising the I-beam 19 and the blocks 20.

In FIG. 9 parts of a further tripod and support system are given identical reference numbers to those of the embodiment shown in FIGS. 1 and 7 of the drawings. In this arrangement, the tripod assembly is secured to a support system comprising a series of individual blocks 25 interlocked with a linking beam 26 (see also FIG. 10). FIG. 11 shows one of the blocks 25 in end view. The blocks incorporates a groove 27 in its top face which receives the linking beam 26. U-shaped bolts 29A are located in grooves 28 formed in the two sides of the block 25 and running around the base. The ends of the bolts will be fixed to securing plates 29B (FIG. 10). Wider U-bolts can be located about a pair of blocks 25 (see FIG. 12).

Each block has a pair of protrusions 30 and a pair of recesses 31 in both side walls so that the blocks can be interlocked with one another (as shown in FIG. 12). This reduces the need for all of the blocks to be positively attached to the linking beam 26. Thus, as shown in FIG. 10, pairs of blocks can be unsecured to the linking beam between two blocks which are positively attached to the beam 26. If desired, at least some of the blocks between those secured to the linking beam can have the top sloping wall section removed to define a half block, as shown in FIG. 13. This also allows attachment plates, such as those shown at 32 in FIG. 9, to be secured to the sides of the linking beam 26 where half blocks 25A are positioned.

The blocks 25 (and 25A) can be locked together in separate sections (four of which are shown in FIG. 10) to allow gaps where flange plates 33 at the ends of individual beams 26 can be bolted together. FIGS. 14A and 14B illustrate how sections of varying lengths can be secured together to form L-shaped structures of any desired length. The cross-hatched blocks 25 illustrated in FIGS. 14A and 14B are those which are secured to the beam 26 (either singly or in pairs) by U-shaped bolts. As shown particularly in FIG. 9 upright supports 34 can be attached to the beam 26 and can then carry hand rails 35 (supported in brackets 36) on the struts 6 and 7 and pole 5.

1. A support base for an upwardly extending structure and comprising a series of individual blocks and a linking structure extending along the length of the line of blocks, the blocks and linking structure being releasably interlocked with one another to form the foot of the base assembly, with the linking structure also providing a mounting area for said structure.

2. An assembly according to claim 1, wherein the blocks have substantial width, relative to their depth in the longitudinal direction of the linking structure.

3. An assembly according to claim 1, wherein the blocks carry at their side faces interengaging protrusions and recesses so that they can be interlocked.

4. An assembly according to claim 3, wherein a securing device interlocking the linking structure to a block is provided for only some of the blocks, with the blocks inbetween those held by securing devices being held together by said interengaging protrusions and recesses.

5. An assembly according to claim 1, wherein each block incorporates a slot running around the sides and base of the block for receipt of a securing device in the form of a U-bolt to be secured to said linking structure or to a plate mounted above said linking structure.

6. An assembly according to claim 1, wherein each block has a groove formed into its top face to house the extending linking structure.

7. An assembly according to claim 1, wherein the linking structure comprises a continuous beam with upper and lower flanges in cross section, and the blocks define slots for fitting over said lower flange section of the beam to lock the blocks to the beam.

8. An assembly according to claim 7, wherein the beam has a horizontal lower flange on which the blocks are to be located.

9. An assembly according to claim 7, wherein the beam has a horizontal upper flange providing the mounting area for the structure to be supported.

10. An assembly according to claim 1, wherein upright supports are secured to said linking structure.

11. An assembly according to claim 10, wherein said supports carry hand rails.

12. A mounting for an antenna, the mounting comprising an upright mounting pole, two base support members in the form of beams extending generally at right angles to one another and connected to said mounting pole and to triangulated support braces mounted between the base support members and said mounting pole.

13. A mounting according to claim 12, wherein mounting rungs are provided on the mounting pole, together with an operating platform carried by horizontal support braces of the triangulated structure.

14. A mounting according to claim 12, wherein parts of the triangulated structure are connected to one another by gusset plates and held by bolts.

15. A mounting according to claim 12, and forming part of a support base assembly comprising a series of individual blocks and a linking structure extending along the length of the line of blocks, the blocks and linking structure being releasably interlocked with one another to form the foot of the base assembly, with the linking structure also providing a mounting area for said structure, wherein the base support members are provided by said linking structure.
